(19) United States
(12) Patent Application Publication
(10) Pub. No.: US 2013/0068545 A1
(43) Pub. Date: Mar. 21, 2013

(54) Split Torque Transmission For Track Type Machine

(71) Applicant: Michael G. Cronin, Peoria, IL (US)

(72) Inventor: Michael G. Cronin, Peoria, IL (US)

(73) Assignee: CATERPILLAR INC., Peoria, IL (US)

(21) Appl. No.: 13/234,272

(22) Filed: Sep. 16, 2011

(51) Int. Cl. B62D 55/06; F16H 47/04

(52) U.S. Cl. 180/9.1; 475/83

(57) ABSTRACT

A split torque transmission for a track type machine includes an internal combustion engine configured to drive a hydrostatic transmission and a mechanical transmission. The hydrostatic transmission includes a variable displacement pump drivingly connected with the internal combustion engine, and a variable displacement motor fluidly connected with the variable displacement pump and having a hydrostatic transmission output. The mechanical transmission has a forward and reverse mechanism drivingly connected with the internal combustion engine. A single stage unconventional planetary gear set is selectively coupled with the hydrostatic transmission output, the forward and reverse mechanism, and a final output, and is configured to sum outputs of the hydrostatic transmission and the mechanical transmission.

### TECHNICAL FIELD

The present disclosure relates generally to a split torque transmission for a track type machine, and more particularly to a split torque transmission including a single stage unconventional planetary gear set for summing outputs of a hydrostatic transmission and a mechanical transmission.

### BACKGROUND

Track type machines include continuous ground engaging tracks that propel the machine along low friction and/or uneven terrain. These machines typically travel at low speeds and are used to push relatively heavy loads. As such, track type machines may benefit from a transmission offering high performance in the low speed range at which the machines typically operate. Some candidate transmissions may include powershift, dual path hydrostatic, series electric, and split torque, with an ideal solution providing a cost competitive, high performance, continuously variable transmission.

U.S. Pat. No. 5,667,452 to Coutant teaches a split torque transmission for a wheel loader, or other machine having an operating speed range of between at least about 0 and 24 miles per hour (mph). The split torque transmission includes an internal combustion engine drivingly connected with a hydrostatic transmission and a mechanical transmission, with a single conventional planetary gear set used to sum the outputs of the hydrostatic transmission and the mechanical transmission. The transmission offers a low speed range, including only hydrostatic output, of between about 0 and 6 mph, and a high speed range, including combined hydrostatic and mechanical transmission output, of between about 6 and 24 mph. While the split torque transmission of the Coutant reference may be satisfactory for particular machines, such as wheeled machines, it may not provide desirable performance characteristics for machines, such as track type machines, having low operating speed ranges.

The present disclosure is directed to one or more of the problems set forth above.

### SUMMARY OF THE DISCLOSURE

In one aspect, a split torque transmission for a track type machine includes an internal combustion engine configured to drive a hydrostatic transmission and a mechanical transmission. The hydrostatic transmission includes a variable displacement pump drivingly connected with the internal combustion engine, and a variable displacement motor fluidly connected with the variable displacement pump and having a hydrostatic transmission output. The mechanical transmission has a forward and reverse mechanism drivingly connected with the internal combustion engine. A single stage unconventional planetary gear set is selectively coupled with the hydrostatic transmission output, the forward and reverse mechanism, and a final output, and is configured to sum outputs of the hydrostatic transmission and the mechanical transmission.

In another aspect, a track type machine having a split torque transmission includes a set of ground engaging tracks supported on a frame and driven by rotation of a final output. A hydrostatic transmission has a variable displacement pump drivingly connected with an internal combustion engine, and a variable displacement motor fluidly connected with the variable displacement pump and having a hydrostatic transmission output. A mechanical transmission has a forward and reverse mechanism drivingly connected with the internal combustion engine. A single stage unconventional planetary gear set is selectively coupled with the hydrostatic transmission output, the forward and reverse mechanism, and the final output, and is configured to sum outputs of the hydrostatic transmission and the mechanical transmission.

In yet another aspect, a method of operating a track type machine includes driving a hydrostatic transmission and a mechanical transmission, both of which are part of a split torque transmission, with an internal combustion engine. The hydrostatic transmission includes a variable displacement pump, a variable displacement motor, and a hydrostatic transmission output. The mechanical transmission includes a forward and reverse mechanism. The method also includes summing outputs of the hydrostatic transmission and the mechanical transmission using a single stage unconventional planetary gear set selectively coupled with the hydrostatic transmission output, the forward and reverse mechanism, and a final output. A set of ground engaging tracks are driven with the final output, such as via a steering mechanism.

### BRIEF DESCRIPTION OF THE DRAWINGS

FIG. 1 is a side diagrammatic view of a track type machine, according to the present disclosure;

FIG. 2 is a schematic view of a split torque transmission for the track type machine of FIG. 1, according to one aspect of the present disclosure;

FIG. 3 is a schematic view of a first low clutch variant of the split torque transmission of FIG. 2, according to another aspect of the present disclosure;

FIG. 4 is a schematic view of a second low clutch variant of the split torque transmission of FIG. 2, according to another aspect of the present disclosure;

FIG. 5 is a schematic view of an alternative embodiment of a split torque transmission having different planetary connectivity than the previous embodiments, according to another aspect of the present disclosure;

FIG. 6 is a schematic view of a first low clutch variant of the split torque transmission of FIG. 5, according to another aspect of the present disclosure;

FIG. 7 is a schematic view of a second low clutch variant of the split torque transmission of FIG. 5, according to another aspect of the present disclosure;

FIG. 8 is a schematic view of an exemplary single stage unconventional planetary gear set for use with the split torque transmissions of the previous Figures, according to another aspect of the present disclosure;

FIG. 9 is a schematic view of another exemplary single stage unconventional planetary gear set for use with the split torque transmissions described herein, according to another aspect of the present disclosure;

FIG. 10 is a schematic representation of a graph showing an exemplary operation of the hydrostatic transmission components relative to machine speed, according to another aspect of the present disclosure; and

FIG. 11 is a schematic representation of a graph showing exemplary operation of the hydrostatic transmission components relative to machine speed for an extended high forward range, according to another aspect of the present disclosure.

### DETAILED DESCRIPTION

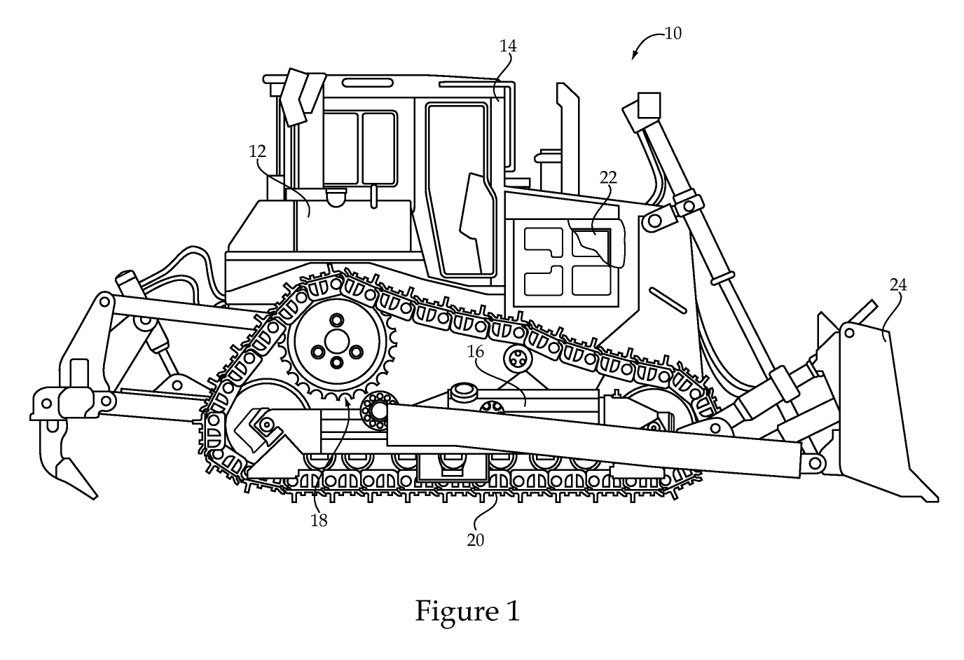

An exemplary embodiment of a track type machine 10 is shown generally in FIG. 1. The track type machine 10 may generally include a machine body 12, which may include an operator control station 14, supported on a frame 16. The frame 16 may also support a propulsion system including a drive assembly 18 for driving a continuous track 20. Although only one continuous track 20 is shown, it should be appreciated that track type machines, such as machine 10, typically include a set of continuous ground engaging tracks for propelling the track type machine 10. Each drive assembly 18 receives power from a steering mechanism (not shown), which receives input from a final output (not shown), which will be discussed later in greater detail, that ultimately receives power from an internal combustion engine 22. The internal combustion engine 22 may power additional systems and/or components of the track type machine 10, including an implement 24, such as a bucket or blade, for hauling or pushing material. Specifically, the internal combustion engine 22 may provide power to a hydraulic system, which powers various components, including the implement 24.

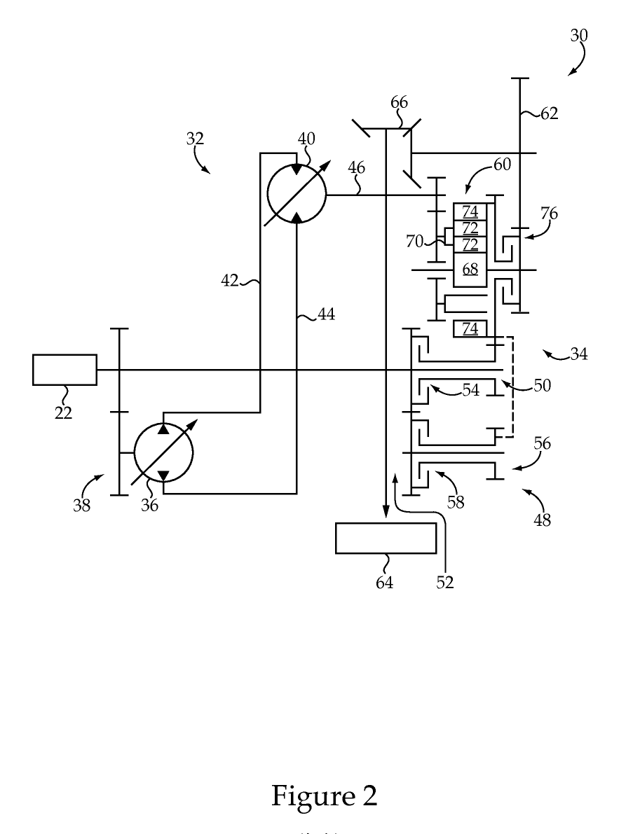

Turning now to FIG. 2, an exemplary schematic of a split torque transmission 30, according to the present disclosure, is shown. The split torque transmission may include the internal combustion engine 22 for driving at least a hydrostatic transmission 32 and a mechanical transmission 34. The hydrostatic transmission 32, also referred to as a variator, may include a variable displacement pump 36 drivingly connected with the internal combustion engine 22 through a pump drive mechanism 38. A variable displacement motor 40 is fluidly connected with the variable displacement pump 36, such as along a closed circuit defined by fluid conduits 42 and 44. As well as being variable, the output of the variable displacement pump 36 may be reversed so that both the direction and speed of rotation of the variable displacement motor 40 may be controlled by the pump 36. The variable displacement motor 40 also includes a hydrostatic transmission output 46.

The mechanical transmission 34 may generally include a forward and reverse mechanism 48, also referred to as a high speed forward and reverse mechanism, drivingly connected with, or at least selectively connectable with, the internal combustion engine 22. For example, the forward and reverse mechanism 48, according to the exemplary embodiment, may include a forward gear 50 drivingly connected with the internal combustion engine 22 through a mechanical drive mechanism 52 when a forward clutch 54, or high forward clutch, is engaged. Similarly, a reverse gear 56 may be drivingly connected with the mechanical drive mechanism 52 through a reverse clutch 58, or high reverse clutch.

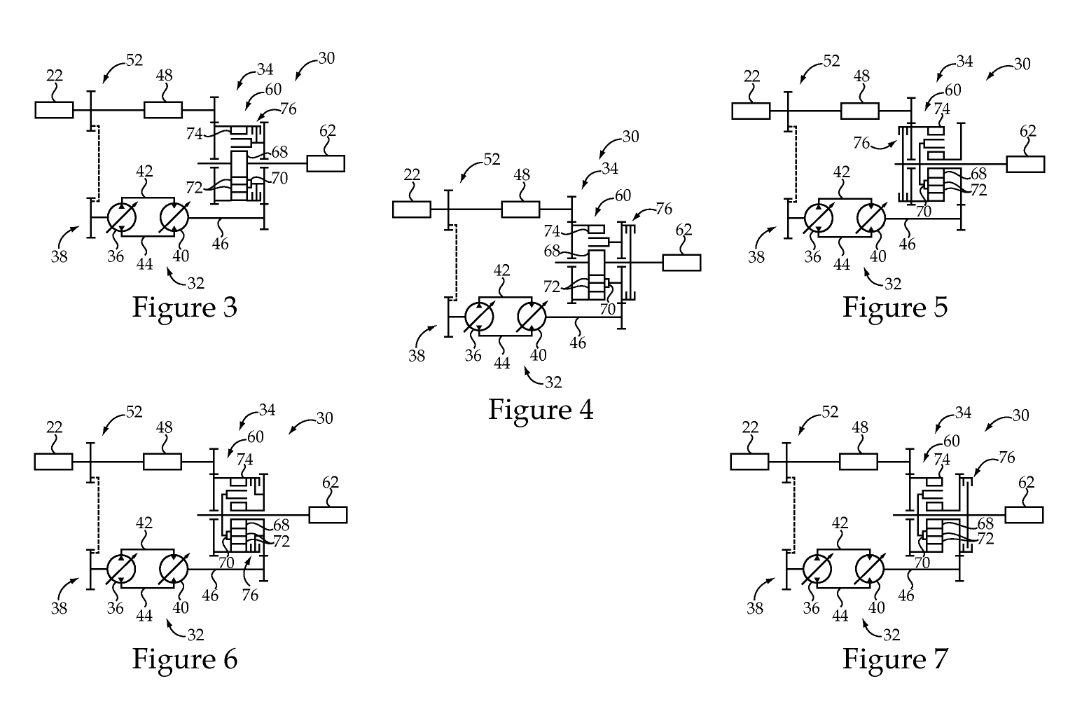

A single stage unconventional planetary gear set 60 may be coupled with, or selectively coupled with, the hydrostatic transmission output 46, the forward and reverse mechanism 48, and a final output 62, and, according to the present disclosure, is configured to sum outputs of the hydrostatic transmission 32 and the mechanical transmission 34. The final output 62, according to the exemplary embodiment, may be drivingly connected with a steering mechanism differential 64 of the machine 10, such as through a bevel gear 66, and may ultimately drive the one or more drive assemblies 18 of FIG. 1. The single stage unconventional planetary gear set 60, which will be discussed in greater detail with reference to FIGS. 3 and 4, may include a single sun gear 68, a single carrier 70 supporting a plurality of sets of double planet gears 72, and a single ring gear 74.

As shown in the exemplary embodiment, the forward and reverse mechanism 48 may be drivingly connected with the single ring gear 74, while the hydrostatic transmission output 46 may be drivingly connected with single carrier 70. When the forward clutch 54 or the reverse clutch 58 of the forward and reverse mechanism 48 is engaged, the outputs of the mechanical transmission 34 and the hydrostatic transmission 32 may be summed using the single stage unconventional planetary gear set 60 and transmitted to the final output 62 through the single sun gear 68. A low clutch 76, which will be engaged only when the forward clutch 54 and the reverse clutch 58 are disengaged, may effectively couple the hydrostatic transmission output 46 with the final output 62 through the single stage unconventional planetary gear set 60. Specifically, low clutch 76 may force the single ring gear 74 and the single sun gear 68 to rotate together, which effectively locks the single stage unconventional planetary gear set 60 to rotate as a unit.

Various alternatives to the embodiment of FIG. 2 are contemplated. For example, as shown in FIG. 3, the low clutch 76 may force the single ring gear 74 and the single carrier 70 to rotate together. According to another low clutch variant, as shown in FIG. 4, the low clutch 76 may force the single sun gear 68 and the single carrier 70 to rotate together. As shown in FIG. 5, the present disclosure also contemplates alternative planetary connectivity. For example, the forward and reverse mechanism 48 may still be drivingly connected with the single ring gear 74. However, the single carrier 70 may be drivingly connected with the final output 62, while the hydrostatic transmission output 46 is drivingly connected with the single sun gear 68. The low clutch 76 may force the single ring gear 74 and single carrier 70 to rotate together, as shown. Low clutch variants of the embodiment of FIG. 5 may include the low clutch 76 forcing the single ring gear 74 and the single sun gear 68 to rotate together (FIG. 6), and the low clutch 76 forcing the single sun gear 68 and the single carrier 70 to rotate together (FIG. 7).

As should be appreciated, variants may be selected based on a number of considerations. For example, a variant may be selected based on the arrangement that provides the best packaging, simplest connections, smallest clutch size, lowest disengaged clutch relative speeds, etc. It should also be appreciated that different machines might favor different variants. Thus, the present disclosure should not be limited to any of the particular embodiments provided herein, as they are provided for exemplary purposes only.

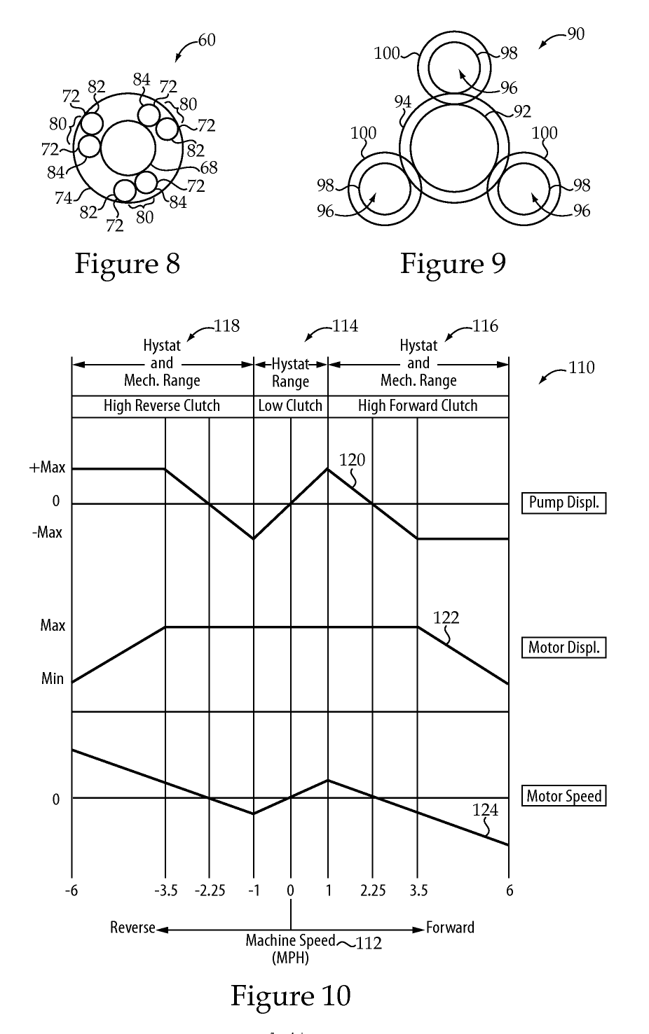

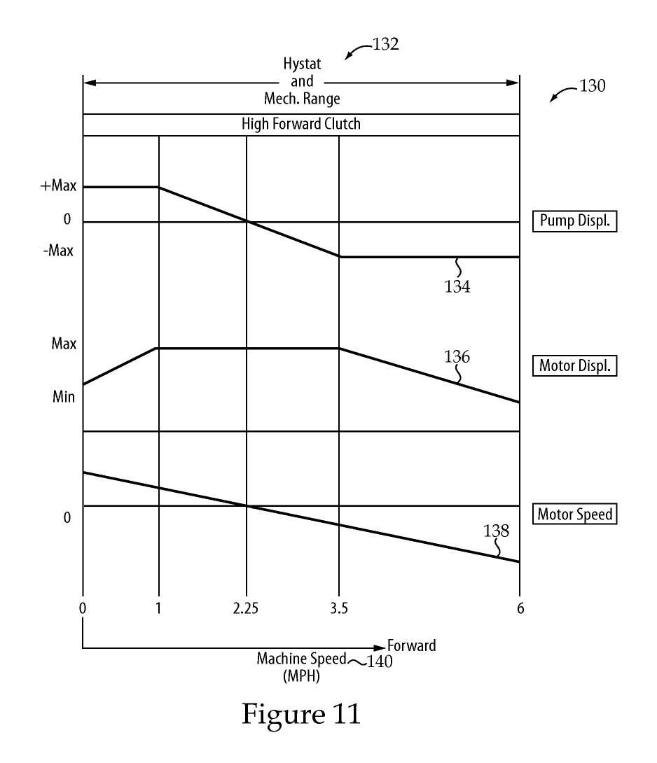

Turning now to FIG. 8, a schematic is shown of the single stage unconventional planetary gear set 60 of the embodiments of FIGS. 2-7. As described above, the single stage unconventional planetary gear set 60, according to the exemplary embodiment, includes the single sun gear 68, the single carrier 70 (not shown in FIG. 8) supporting the sets of double planet gears 72, and the single ring gear 74. Specifically, as shown, the single stage unconventional planetary gear set 60 may include three or more sets 80 of double planet gears 72, with each of the sets 80 including an outer planet gear 82 and an inner planet gear 84. The outer planet gears 82 are in mesh with the single ring gear 74 and the inner planet gears 84, and the inner planet gears 84 are in mesh with the outer planet gears 82 and the single sun gear 68. Thus, as the single sun gear 68 rotates in a clockwise direction, the inner planet gears 84 and outer planet gears 82 are drivingly engaged to rotate the single ring gear 74 in the same clockwise direction.

An alternative single stage unconventional planetary gear set for use with the split torque transmission 30 described herein is shown generally in FIG. 9. Specifically, a cluster planet gear set 90 may be used as an alternative to the single stage unconventional planetary gear set 60 of the previous Figures. The current single stage unconventional planetary gear set 90 includes a small sun gear 92, a large sun gear 94, and a planet carrier 96. The planet carrier 96 supports a small planet gear 98, which meshes with the large sun gear 94, and a large planet gear 100, which meshes with the small sun gear 92. The small and large planet gears 98 and 100 are coupled such that they rotate together. The function of the small sun gear 92 may be similar to that of the sun gear 68 of the single stage unconventional planetary gear set 60 of the previous Figures, the large sun gear 94 may function similarly to the ring gear 74, and the carrier 96 may function similarly to the carrier 70.

The unconventional planetary gear sets 60 and 90 described herein are provided for exemplary purposes only. It should be appreciated that an alternative gear set capable of providing the performance characteristics described herein may be used with the disclosed split torque transmission 30. The term “unconventional” describes a planetary gear set other than a “conventional” planetary gear set, wherein a conventional planetary gear set includes a ring gear, a sun gear, and a carrier supporting one or more planet gears. A key distinction being that the conventional planetary gear set includes singular planet gears that are in mesh with the sun gear and the ring gear, whereas the unconventional planetary gear set 60 includes the sets 80 of double planet gears 72, as shown in FIG. 8. The cluster planet gear set 90 is also considered “unconventional” since it does not fall into the category of a conventional planetary gear set. To reduce complexity, an unconventional planetary gear set, as used herein, provides summing during one stage, rather than across a plurality of stages.

Turning now to FIG. 10, a graph 110 of an exemplary operation of components of the hydrostatic transmission 32 relative to the ground speed 112, or machine speed, in miles per hour (mph) of the track type machine 10 is shown. The graph 110 depicts a low speed range 114 between about −1 and 1 mph, during which the low clutch 76 is engaged, the forward and reverse clutches 54 and 58 are disengaged, and only the hydrostatic transmission 32 is operatively connected to the final output 62 to propel the track type machine 10. Also depicted is a high forward speed range 116 between about 1 and 6 mph, during which the low clutch 76 and the reverse clutch 58 are disengaged, the forward clutch 54 is engaged, and the single stage unconventional planetary gear set 60 sums the outputs of the hydrostatic transmission 32 and the mechanical transmission 34 to drive the final output 62 and, thus, machine 10. During a high reverse speed range 118 the low clutch 76 and the forward clutch 54 are disengaged, the reverse clutch 58 is engaged, and the single stage unconventional planetary gear set 60 sums the outputs of the hydrostatic transmission 32 and the mechanical transmission 34 to propel the track type machine 10 in the reverse direction at a speed range between about −1 and −6 mph.

Adjustment of the displacement of the variable displacement pump 36 throughout the high reverse speed range 118, low speed range 114, and high forward speed range 116 is shown on the graph 110 as pump displacement 120, which may be varied between maximum displacement in a first direction and maximum displacement in a reverse direction that is opposite the first direction. Displacement of the variable displacement motor 40 across the speed ranges 114-118 is shown as motor displacement 122, which may be varied between minimum displacement and maximum displacement. Motor speed, as affected by pump displacement 120 and motor displacement 122, is shown as motor speed 124 on the graph 110.

### INDUSTRIAL APPLICABILITY

The present disclosure may be applicable to transmissions for machines that primarily operate at relatively low speeds. Further, the present disclosure may be applicable to transmissions for track type machines that operate at low speeds and push relatively heavy loads. Yet further, the present disclosure may be applicable to transmissions providing high efficiency and smooth transitions across the low operating speed range of the track type machine.

Referring generally to FIGS. 1-10, an exemplary schematic of a split torque transmission 30 for a track type machine 10 includes an internal combustion engine 22 for driving at least a hydrostatic transmission 32 and a mechanical transmission 34. The hydrostatic transmission 32 includes a variable displacement pump 36 drivingly connected with the internal combustion engine 22 through a pump drive mechanism 38. A variable displacement motor 40 is fluidly connected with the variable displacement pump 36 and includes a hydrostatic transmission output 46. The mechanical transmission 34 includes a high speed forward and reverse mechanism 48 drivingly connected with the internal combustion engine 22. The forward and reverse mechanism 48 includes a forward gear 50 drivingly connected with the internal combustion engine 22 through a mechanical drive mechanism 52 when a high forward clutch 54 is engaged, and a reverse gear 56 drivingly connected with the mechanical drive mechanism 52 through a high reverse clutch 58. A single stage unconventional planetary gear set 60 is coupled, or selectively coupled, with the hydrostatic transmission output 46, the forward and reverse mechanism 48, and a final output 62, and is configured to sum outputs of the hydrostatic transmission 32 and the mechanical transmission 34.

When the track type machine 10 is stationary (i.e., the machine speed is 0 mph), the low clutch 76, the high forward clutch 54, and the high reverse clutch 58 are disengaged. The variable displacement pump 36 is at zero displacement, the variable displacement motor 40 is at maximum displacement, and the motor speed 124 is 0 mph. The internal combustion engine 22 is configured to drive both the hydrostatic transmission 32 and the mechanical transmission 34. Specifically, the internal combustion engine 22 may drivingly engage the variable displacement pump 36 of the hydrostatic transmission 32 and the forward and reverse mechanism 48 of the mechanical transmission 34.

To propel the track type machine 10 at the low speed range 114, the low clutch 76 may be engaged. Specifically, the low clutch 76 may lock the single stage unconventional planetary gear set 60 to rotate as a unit, such that the hydrostatic transmission 32 drives the final output 62. More specifically, according to the embodiment of FIG. 2, the low clutch 76 may force the single ring gear 74 and the single sun gear 68 to rotate together, which effectively locks the single stage unconventional planetary gear set 60 to rotate as a unit. The final output 62 drives the set of continuous ground engaging tracks 20 and, thus, propels the track type machine 10. As the machine speed 112 moves from about 0 mph to about 1 mph, the pump displacement 120 goes from zero displacement to maximum displacement, the motor displacement 122 is maintained at maximum displacement, and the motor speed 124 increases.

At about 1 mph, the low clutch 76 is disengaged and the high forward clutch 54 is engaged to propel the track type machine 10 at the high speed range 116. This shift may be substantially synchronous. According to the high speed range 116, the hydrostatic transmission output 46 is drivingly connected with the single carrier 70, and the high forward clutch 54 is engaged to drivingly connect the high forward gear 50 with the single ring gear 74. The outputs of the hydrostatic transmission 32 and the mechanical transmission 34 are summed using the single stage unconventional planetary gear set 60 and transmitted to the final output 62 using the single sun gear 68.

From about 1 mph to about 2.25 mph, the pump displacement 120 is decreased from maximum displacement to zero displacement, the motor displacement 122 is maintained at maximum displacement, and the motor speed is reduced to zero. As should be appreciated, the hydrostatic transmission 32 and the mechanical transmission 34 interact to increase machine speed 112 during this speed range. From about 2.25 mph to about 3.5 mph, the pump displacement 120 is moved to its maximum displacement in the opposite direction, the motor displacement 122 is maintained at maximum displacement, and the motor speed 124 is increased in the opposite, or reverse, direction. From about 3.5 mph to about 6 mph, the pump displacement 120 is maintained at maximum displacement, the motor displacement 122 is now decreased from maximum displacement to minimum displacement, and the motor speed 124 continues to increase. As shown in the graph 110, the motor displacement 122 is decreased from maximum displacement to about one half to about one third of maximum displacement during a second half of the high speed range 116.

The track type machine 10 can be operated through the same speed ranges in the reverse direction, as shown in the graph 110. Specifically, the track type machine 10 may be operated in the reverse direction through the low speed range 114 and the high reverse speed range 118. Between about 0 mph and about −1 mph, the low clutch 76 may lock the single stage unconventional planetary gear set 60 such that the hydrostatic transmission 32 drives the final output 62. As the machine speed 112 moves from about 0 mph to about −1 mph, the pump displacement 120 goes from zero to maximum in the opposite direction as described with respect to the forward direction, the motor displacement 122 is maintained at maximum, and the motor speed 124 increases in a direction opposite of that described with respect to the forward direction.

At about −1 mph, the low clutch 76 is disengaged and the high reverse clutch 58 is engaged to propel the track type machine 10 at the high reverse range 118. From about −1 mph to about −2.25 mph, the pump displacement 120 is decreased from maximum displacement to zero displacement, the motor displacement 122 is maintained at maximum displacement, and the motor speed is reduced to zero. From about −2.25 mph to about −3.5 mph, the pump displacement 120 is moved to its maximum displacement in the opposite direction, the motor displacement 122 is maintained at maximum displacement, and the motor speed 124 is increased in the opposite, or reverse, direction. From about −3.5 mph to about −6 mph, the pump displacement 120 is maintained at maximum displacement, the motor displacement 122 is now decreased from maximum displacement to minimum displacement, and the motor speed 124 continues to increase.

According to some embodiments, the split torque transmission 30 may be configured to provide combined hydrostatic and mechanical outputs throughout the entire forward and reverse speed ranges. Specifically, as shown in the graph 130, the low speed range 114 of FIG. 10 may not be provided, and a forward range 132 may cover a speed range between about 0 mph and 6 mph. Although not shown, a reverse range may cover a speed range between about 0 mph and −6 mph. During the extended high forward range 132, the low clutch 76 and the reverse clutch 58 are disengaged, the forward clutch 54 is engaged, and the single stage unconventional planetary gear set 60, or 90, sums the outputs of the hydrostatic transmission 32 and the mechanical transmission 34 to drive the machine 10. Also shown on the graph 130, according to an exemplary control strategy, is pump displacement 134, motor displacement 136, and motor speed 138, all relative to machine speed 140.

According to all embodiments, the split torque transmission 30 may include the single stage unconventional planetary gear set 60 that sums outputs of the hydrostatic transmission 32 and the mechanical transmission 34 over a speed ratio range of at least six. For example, according to the exemplary embodiment, the split torque transmission provides summed output at a high speed of about 6 mph and a low speed of about 1 mph, with the speed ratio range being equal to the high speed (6) divided by the low speed (1).

The split torque transmission disclosed herein provides high efficiency, infinite adjustability, and precise control at a broader range of low speeds, when compared to previous transmission designs, and, as such, is particularly well suited for track type machines. Since a large number of track type machines primarily operate between about 1 mph and about 6 mph, and oftentimes only between about 1 mph and 3.5 mph, it may be desirable to provide the combined outputs of the hydrostatic transmission and the mechanical transmission at least during this speed range. Further, it may be desirable to position any transitions from different speed ranges, including clutch changes and motor control changes, outside this productive operating speed range to eliminate or reduce potential power interruptions and control complexity. It should be noted that speeds faster than the productive operating speed range may be used for transport and/or rapid reversing, while speeds slower than the productive operating speed range may used at launch and during transitions from forward to reverse and vice versa.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A split torque transmission for a track type machine, including:
an internal combustion engine;
a hydrostatic transmission having a variable displacement pump drivingly connected with the internal combustion engine, and a variable displacement motor fluidly connected with the variable displacement pump and having a hydrostatic transmission output;
a mechanical transmission having a forward and reverse mechanism drivingly connected with the internal combustion engine; and
a single stage unconventional planetary gear set selectively coupled with the hydrostatic transmission output, the forward and reverse mechanism, and a final output, wherein the single stage unconventional planetary gear set sums outputs of the hydrostatic transmission and the mechanical transmission.

2. The split torque transmission of claim 1, wherein the single stage unconventional planetary gear set sums outputs over a speed ratio range of at least six.

3. The split torque transmission of claim 2, further including a low speed range in which a low clutch couples the hydrostatic transmission output with the final output through the single stage unconventional planetary gear set, and the forward and reverse mechanism is drivingly disengaged from the single stage unconventional single planetary gear set.

4. The split torque transmission of claim 3, further including a high forward speed range wherein a high forward clutch is engaged to drivingly connect a forward gear of the forward and reverse mechanism with the single stage unconventional planetary gear set, and a high reverse speed range wherein a high reverse clutch is engaged to drivingly connect a reverse gear of the forward and reverse mechanism with the single stage unconventional planetary gear set, wherein the hydrostatic transmission output is drivingly connected with the single stage unconventional planetary gear set in both the high forward speed range and the high reverse speed range.

5. The split torque transmission of claim 4, wherein the single stage unconventional planetary gear set includes a single sun gear, a single carrier supporting a plurality of sets of double planet gears, and a single ring gear, wherein outer planet gears of the sets of double planet gears are in mesh with the single ring gear and inner planet gears of the sets of double planet gears, wherein the inner planets are in mesh with the outer planets and the single sun gear.

6. The split torque transmission of claim 5, wherein, in the high forward speed range and the high reverse speed range, the forward and reverse mechanism is drivingly connected with the single ring gear.

7. The split torque transmission of claim 6, wherein the single sun gear is drivingly connected with the final output.

8. The split torque transmission of claim 7, wherein the hydrostatic transmission output is drivingly connected with the single carrier.

9. The split torque transmission of claim 6, wherein the single carrier is drivingly connected with the final output.

10. The split torque transmission of claim 9, wherein the hydrostatic transmission output is drivingly connected with the single sun gear.

11. A track type machine, including:
a frame;
a set of ground engaging tracks supported on the frame and driven by rotation of a final output; and
a split torque transmission including:
an internal combustion engine;
a hydrostatic transmission having a variable displacement pump drivingly connected with the internal combustion engine, and a variable displacement motor fluidly connected with the variable displacement pump and having a hydrostatic transmission output;
a mechanical transmission having a forward and reverse mechanism drivingly connected with the internal combustion engine; and
a single stage unconventional planetary gear set selectively coupled with the hydrostatic transmission output, the forward and reverse mechanism, and the final output, wherein the single stage unconventional planetary gear set sums outputs of the hydrostatic transmission and the mechanical transmission.

12. The track type machine of claim 11, further including a forward speed range wherein a forward clutch is engaged to drivingly connect a forward gear of the forward and reverse mechanism with the single stage unconventional planetary gear set, and a reverse speed range wherein a reverse clutch is engaged to drivingly connect a reverse gear of the forward and reverse mechanism with the single stage unconventional planetary gear set, wherein the hydrostatic transmission output is drivingly connected with the single stage unconventional planetary gear set in both the forward speed range and the reverse speed range.

13. The track type machine of claim 12, wherein the forward speed range and the reverse speed range are high speed ranges, and the track type machine further includes a low speed range in which a low clutch couples the hydrostatic transmission output with the final output through the single stage unconventional planetary gear set, and the both the forward clutch and the reverse clutch are drivingly disengaged from the single stage unconventional single planetary gear set.

14. The track type machine of claim 13, wherein the single stage unconventional planetary gear set includes a single sun gear, a single carrier supporting a plurality of sets of double planet gears, and a single ring gear, wherein outer planet gears of the sets of double planet gears are in mesh with the single ring gear and inner planet gears of the sets of double planet gears, wherein the inner planets are in mesh with the outer planets and the single sun gear.

15. A method of operating a track type machine, including steps of:
driving a hydrostatic transmission of a split torque transmission with an internal combustion engine, wherein the hydrostatic transmission includes a variable displacement pump, a variable displacement motor, and a hydrostatic transmission output;
driving a mechanical transmission of the split torque transmission with the internal combustion engine, wherein the mechanical transmission includes a forward and reverse mechanism;
summing outputs of the hydrostatic transmission and the mechanical transmission using a single stage unconventional planetary gear set selectively coupled with the hydrostatic transmission output, the forward and reverse mechanism, and a final output; and
driving a set of ground engaging tracks with the final output.

16. The method of claim 15, further including propelling the track type machine at a low speed range by:
maintaining a drivingly disengaged position of a high forward clutch and a high reverse clutch of the forward and reverse mechanism; and
engaging a low clutch to couple the hydrostatic transmission output with the final output through the single stage unconventional planetary gear set.

17. The method of claim 16, wherein the engaging step includes locking the single stage unconventional planetary gear set to rotate as a unit.

18. The method of claim 16, further including propelling the track type machine at a high speed range by:
disengaging the low clutch; and
engaging the high forward clutch to drivingly connect a forward gear of the forward and reverse mechanism with the single stage unconventional planetary gear set.

19. The method of claim 18, wherein propelling the track type machine at the low speed range includes maintaining a maximum displacement of the variable displacement motor throughout the low speed range.

20. The method of claim 19, wherein propelling the track type machine at the high speed range includes decreasing the maximum displacement of the variable displacement motor to about one half to about one third the maximum displacement during a second half of the high speed range.
